(19) United States
(12) Patent Application Publication
(10) Pub. No.: US 2012/0293089 A1
(43) Pub. Date: Nov. 22, 2012

(54) DEVICE FOR IGNITION AND OPERATING DISCHARGE TUBES BY USING ENERGY IMPULSE AND RESONANCE CIRCUIT

(75) Inventor: Kálmán Csikszentimrei, Szeged (HU)

(73) Assignee: GRADIX HOLDING LTD., Mahe (SC)

(21) Appl. No.: 13/575,509

(22) PCT Filed: Jan. 4, 2011
(86) PCT No.: PCT/HU2011/000001

§ 371 Date: Jul. 26, 2012

(30) Foreign Application Priority Data
Jan. 27, 2010 (HU) P1000062

(51) Int. Cl. H05B 41/282

(52) U.S. Cl. 315/224

(57) ABSTRACT

The invention relates to a device for ignition and operation of discharge tubes in an energy saving mode and using a bridge-coupled DC/AC converter. The discharge tube is connected to the AC output of the bridge-coupled device. The essence of the invention lies in that the condenser (7) is coupled parallel with the discharge tube (6) and an inductive coil (5) is coupled in series in a way that they forming together an oscillating circuit. One of the half-bridge is formed by two semiconductor switching elements (1, 2) the control electrodes of which are connected to the outputs (20, 21) of a signal generator (10, 21) providing alternatively impulses shifted in time to control electrodes. Control impulses exciting a current through the tube (6) in opposite directions, and disconnecting the semiconductor switching elements (1,2) in the intervals between the impulses. The other half-bridge consists of AC coupling elements connected to the other input (9,8) and to the serial coupled circuit comprising the semiconductor switching elements (2, 1) actually switched on, the inductive coil (5) and the fluorescent lamp (6).

### FIELD OF THE INVENTION

The invention relates to a device for ignition and operating discharge tubes by using energy impulses and resonance circuit by means of which the discharge lamps can be ignited and operated in an energy saving mode, i.e. the device of the invention can produce the same result by consuming less energy than the energy consumption of the traditional equipments.

### BACKGROUND OF THE INVENTION

### General Description

Gas discharge plasma tubes, such as fluorescent lamps and other metal-halogen tubes provide light with a significantly better efficiency than electric bulbs do. Fluorescent lamp is a discharge tube, and the lighting devices using these lamps are the so called discharge lamps. Discharge lamps are constructed so that in each end of a hermetically closed glass tube an electrode, in fluorescent tubes heating filaments are placed, and the internal wall of the tube transforms it to visible light.

### Traditional, Inductive Ignition and Operation has Two Types:

Two-points, pulse ignition
Three-points, serial, superposition ignition.

During operating the fluorescent lamp by means of a traditional adapter, immediately after switching it on, the electrodes, heater filaments are inflamed, this ionizes the gas charge of the tube, and the mercury precipitated eventually on the heating filament evaporates as well. After heating up, current starts to be generated through the inductive (ionized) gas charge, which is usually confided to its operating value by a serially coupled, iron-cored coil provided with an air gap dimensioned to 50 Hz. After that, the current flowing through ensures to maintain the ionization in the gas in order to keep the mercury being in the tube in vapour state. Supplying with 50 Hz, at the zero transitions of the alternating current the light is extinguished, i.e. the lamp flickers, which is though not seen due to the speed of flickering, it is tiring for the eye, and when used in the neighbourhood of rotating machines, it may cause stroboscopic effects which can be dangerous.

### Electronic Ignition and Operation of Prior Art

A device for electronic ignition and operation of discharge lamps comprise the following parts: noise trap (suppressor), rectifier, DC/AC converter, ignition unit, driver unit, current stabilizer and controller unit and cathode preheating unit.

Operation of the ignition and operating device described above is the following: first the supply mains voltage is filtered and rectified. The rectified signal is coupled to the input of an DC/AC converter which converts the input signal to an output AC signal of 40-90 kHz frequency, which signal operates the ignition and the driving units. A control unit controls the operation of the DC/AC converter and the operating current. The operation frequency and temperature of the electrodes are ensured by a preheating unit. This arrangement has several advantages. The size of the adapter choke coil belonging to the fluorescent lamp can be small owing to the high operation frequency. In an ideal case, the fluorescent lamp does not flicker, as it is supplied with a voltage of 50 Hz frequency, since the light powder in it cannot follow the periods of the AC of 40 kHz frequency. Owing to the quick ignition of the fluorescent lamp, there is no 50/100 Hz flickering during operation.

### Operation of the Prior Art Devices

Ignition devices used until now are all operating in a similar way. The difference is essentially only in the operating frequency. The ignition and operation of fluorescent tubes are substantially the same. Before starting discharge in the fluorescent tube, the electrodes should be heated up. Heating of the electrodes is realized by a separate circuit. The glowing electrodes of very high temperatures of 500-800° C. are capable of emission, i.e. they ionize the tube. Current flows in the tube only when the electrodes have taken up their operation temperature, thus the gas charge is ionized. At that point, the resistance of the tube decreases rapidly, the current starts to increase, and glow-discharge comes into being, which, if it would not be restricted, would create arc discharge ruining the tube. Discharge is ensured by a sinusoidal alternating current. The frequency of the AC is determined by the resonance of elements independent of the tube, or by the properties of the AC used. Thus, the discharge tube operates in a forced oscillatory mode determined by external elements. This way, the role of the “anode” and “cathode” is steadily alternating. The peak value of the current in sinusoidal curve will be reached in about 5 ms-2 μs, afterwards it will decay in the same time according to a sinusoidal curve. Free electrons collide with atoms. This collision may be elastic or inelastic. Elastic collisions cause heat which is unfavourable from light technical viewpoint. Inelastic collisions ionize, increasing thereby the current density and making the discharge self-supporting, and, on the other hand, they excite the atoms leading to light emission. Thermal agitation, charge flow directed by field strength, ambipolar diffusion, i.e. gas discharge plasma is thus generated.

If current is restricted to the operation value by means of some devices, the fluorescent tube operates continuously in the range of 50-200 V voltage and 50-500 mA current. Discharge should be in the range of glow discharge. Supplying with short impulses having high amplitude, the fluorescent tube operates not in the glow discharge zone, but a series of arc discharges develop, decreasing the efficiency and life time of the fluorescent tube. According to practical experience, the fluorescent lamp is a strongly non-linear, unstable device, its resistance is constantly changing, it is practically impossible to use in normal operation without current restriction. It may be optimally operated by symmetrical AC voltage (f>10 kHz) which does not contain any DC component. An additional problem is that the two ends of the tube do not heat up to the same degree, especially if the signal form is asymmetrical, then the tube shows different resistances at its two ends, it starts to rectify, a DC component appears in the current that leads to a further decrease in the efficiency and life time of the tube.

U.S. Pat. No. 6,316,882 discloses a device for operation of discharge tubes using bridge-coupled DC/AC converter circuit the main elements of which are similar to the circuit used in our invention. One half-bridge of the bridge circuit comprising condensers and the other half-bridge of the bridge-circuit comprising controlled switching elements coupled to a signal generator.

### Objective of the Invention

The objective of present invention lies in developing an energy saving device for the ignition and operation of discharge lamps i.e. during operation the device of present invention has the same results the than the ones used until now but the energy consumption is significantly decreased. It means that at keeping the illumination power, the discharge lamps can be operated with less energy. Ignition should be immediately developed in the discharge lamps. A further objective is that no flickering should occur, the light should be continuous and the illuminating power of the tube could be controlled. Another objective of the invention is to make the life time of fluorescent lamps longer.

### Recognition of the Invention

According to our recognition, the gas discharge plasma state can be preserved even if no energy is supplied into the plasma. This means that less energy is needed to create and preserve the gas discharge plasma as compared to the solutions applied until now. This is realized so that plasma is created by an energy impulse, then it is closed, together with a resonator circuit, and galvanic separated. The switching elements being on the input are in this operation period in a closed state of 5-10 Mohm. The energy impulse is kept in a closed system defined by the discharge tube and the resonator. Considering that one end of the tube is charged by the energy impulse, electrons start to flow, and in effect of the resonator resonance develops, thus the discharge tube and the resonator form an oscillating circuit. In this closed system, the plasma state remains preserved on the resonance frequency till the using up of the energy. The resonance frequency is determined by the discharge tube and the resonator. Thus the discharge tube operates at its own oscillation frequency. The resonator can be preferably an inductive coil.

A further recognition of the invention lies in that, the gas discharge plasma can be kept at the same level with using less energy as in the former solutions, if the energy impulses get into the system at a resonance frequency determined by the oscillating circuit formed by the discharge tube and the inductive coil, in a synchronous phase. To keep up a resonance frequency requires less energy than to operate a forced oscillation.

A further recognition concerns the properties of energy impulses. Electrons are supplied rapidly to the electrode of the tube, and to the resonance circuit consisting of the tube and the inductive coil, i.e. a current is supplied the leading-edge of which is less than 200 ns, which is less than used according to the prior art. The charge impulse is ensured by a square wave signal. Voltage should be in the range of 100-300 V so that a glow charge is generated. The steep leading-edge can be produced by high speed semiconductor devices. The end of the energy impulse is performed by quick closing the semiconductor elements. The decay time of the square wave signal is less than 200 ns.

According to our recognition, the electrodes of the discharge tube have not to be heated, thus no extra wiring and circuit is required. The effect of the impulse, i.e the voltage the leading-edge of which shorter than 200 ns, results in that the electrons emit the electrode, during their emission, they heat up the electrode.

Another recognition of present invention lies in that the magnitude of the impulse can be set by two factors: by its length and its voltage. The length of the impulse is determined by the quantity of the charge needed. In turn, the magnitude and voltage of the charge is determined by the type of the discharge tube used. It is different for fluorescent lamps and for a metal-halogen lamps.

We have recognized that the operating impulse has two phases. Two phases are repeated with a pause between them, one of the impulses develops a current into one direction of the tube, whereas the other one develops a current in the opposite direction. During the pauses, the tube and the inductive coil are in galvanic separated, insulated state. The roles of the electrodes should be exchanged in order to keep up the symmetry of the operating current. The one being anode in the first phase, will be cathode in the second phase, and inversely. In the first phase, one of the electrodes is the anode, the other one is the cathode, in the second phase the one electrode is the cathode, the other one the anode, and this is repeated. The impulses are identical in the two phases, i.e. the amounts of the charges getting to the electrodes are the same, thus the operation is symmetrical. The lengths of the pauses are also identical in the two phases, i.e. the time left for resonance is also the same thus the operation is symmetrical.

According to our further recognitions the illumination power can be controlled by decreasing or increasing the impulse rate. If the electrode and the gas are hot, the following impulse ignites the tube immediately. The length of the interval between the impulses plays also the role of regulating the illumination power.

According to our further recognition the advantage of the invention lies among others in that the life time of the electrodes is elongated. The failure of fluorescent lamps is caused usually by the reduction of the electron emitting power or the breaking of the electrode. The decrease in the electron emitting capacity of the electrodes is a consequence of a faulty recombination on them, which is caused, in turn, by the operation at a forced frequency. Recombination is perfect if the operation of the fluorescent lamp is fully symmetrical, and if it functions at its own resonance frequency. In case of an impulse driven resonance ignition, recombination is spontaneous and symmetrical. As there is no heating up in the case of impulse driven resonance ignition, the tube operates also with a broken electrode.

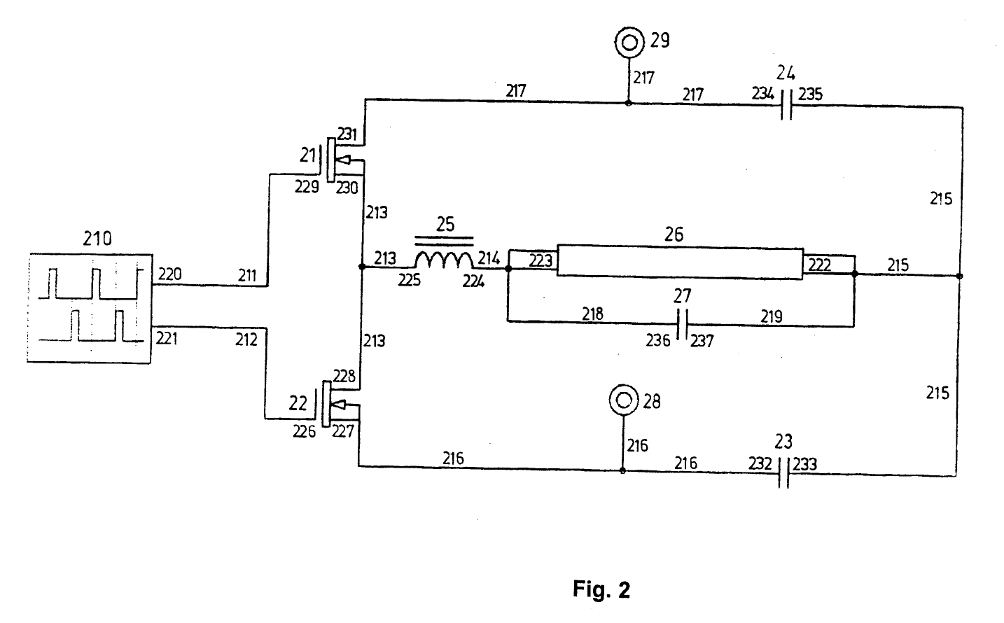

According to our recognition, the other half bridge of the bridge circuit may be any element ensuring electric AC connection to the supply voltage without a semiconductor switching element. Such an embodiment is shown in FIG. 2, where the element ensuring AC coupling is a condenser.

We recognized, namely, that the capacity of condensers used in half bridges regulate the magnitude of the impulse, since the charges accumulated on the armature are led into the discharge tube in the conductive state of the semiconductors of the other half of the bridge, or they charge up the armatures with reduced amount of charges. The condenser ensures an ever decreasing current during its charging-discharging process, according to the charge-discharge characteristic of the condenser. It is the opposite of the situation, when the second half bridge is also semiconductor, then the size of the current is nearly the same in the period of the switched on state of the semiconductors.

A further recognition is that the capacity of condensers used in half bridge couplings determines the maximum magnitude of the impulses, as it is capable to transmit electrons into the discharge tube up to the amount of accumulated charges on the armatures. In the other half bridge, the semiconductors remain in vain in connected state, if the charges on the armatures are used up, or if the armature is charged up, the electrons cease to flow.

On the basis of these recognitions, the operation of the device according to present invention is as follows:

Charge is forwarded to one of the electrodes, in this phase it works as cathode, by a voltage the amplitude of which is of 100-300 V and the raise time of which is less than 2 μs, preferably less than 200 ns. The electrons rapidly introduced to the electrode strive for leaving the electrode also rapidly. Due to the movement and escape of the electrons, the electrodes are heated up, ionization occurs and discharge forms. After that, the electrodes are galvanic separated within a decay time less than 2 μs, preferably less than 200 ns. Then, resonance starts. During the resonance time, the gas discharge plasma is maintained, thus light emission is continuous. After that, the role of electrodes is changed, and the other electrode works as cathode, after galvanic separation the process is repeated.

The condenser coupled parallel with the fluorescent tube has a role only until plasma is formed. The capacitance value of the condenser used is some nF, preferably 2 nF. In cooperation with the inductive coil, it gives a higher voltage to the electrode than the operation voltage, accelerating thereby the heating up of the electrode in a raise time of less than 1 ms which cannot be observed by human eye at all. After the formation of the plasma, it has no role and effect any more. It is because due to the effect of the plasma the internal resistance, conductivity of the fluorescent tube differs by three orders of magnitude from that of the condenser the capacitance of which is some nF. If a slower visible ignition of 10-400 ms is also suitable, the condenser can be left out.

The control signal generator has two outlets producing square wave signals shifted in phase. The shifts in the two signals are identical. This means that the interval between the impulses through the tube in opposite directions is always the same. The magnitude of the impulses can be controlled by the length of the high voltage square wave signal. The isolated, self-oscillating state can be achieved by the zero voltage state of the square wave signal.

Thus the invention relates to a device for the ignition and operation of a discharge tube by a DC/AC transformer in bridge coupling, where the discharge tube is connected to the AC outlet of the bridge coupling.

The essence of the invention is that a condenser is coupled parallel with the discharge tube and an inductive coil is coupled in series with the discharge tube, and they form together an oscillating circuit of a given resonance frequency; and the device involves further a bridge circuit, at least one of the half bridges of the bridge-circuit is formed by two semiconductor switching elements coupled in series between the two inputs, the control electrodes (gates) of which are connected to the outputs of the signal generator which provide alternatively impulses to the control electrodes which are shifted in time and exciting current flowing in the tube in the opposite direction and disconnecting the semiconductor switching elements in the intervals between the impulses bringing in this way into resonance the oscillating circuit comprising the inductive coil and the discharge tube; whereas the other half bridge consist of elements ensuring an AC coupling to the other input and coupled to the serial circuit comprising the semiconductor switching element being currently switched on the inductive coil and the fluorescent tube.

The other half bridge is formed by two semiconductor switching elements coupled in series, or by two, serial coupled condensers.

The magnitude of the impulse can be controlled by changing the capacity of the condensers, and the capacity of the condensers determines the maximum value of the impulse.

The duration of the control impulses and the intervals between the impulses are the same, and the control impulses are preferably square wave signals, where the shifts in the two control signals are identical, and the duration of impulses and intervals between the impulses are also identical.

The illumination power can be controlled by controlling the pulse rate.

The capacity of the condenser coupled parallel to the fluorescent lamp is some nF, preferably 2 nF.

Embodiments of present invention will now be described in detail by way of examples in figures.

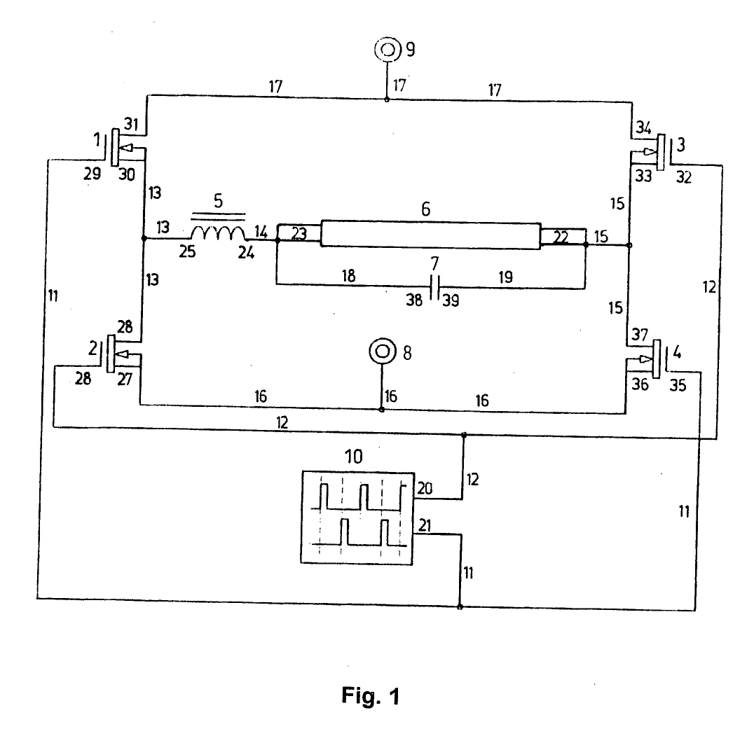

FIG. 1 shows an embodiment the device of the invention used for ignition and operating discharge tube in which semiconductor switching elements are used.

FIG. 2 shows another embodiment of the device of the invention.

In the embodiment shown in FIG. 1, the semiconductor switching element is a MOFSET. Any other semiconductor element can be used as mentioned in the description earlier.

In FIG. 1, a fluorescent lamp 6 is shown in which two terminals of its four terminals are connected and they form the outputs 22 and 23 of the fluorescent lamp 6, which means that fluorescent lamp 6 does not need any heating circuit for its electrodes. Fluorescent lamps are produced nowadays with four terminals, thus they can be transformed to the new ignition devices. An inductive coil 5 is connected in series with the fluorescent lamp 6 whereas parallel with the fluorescent lamp 6 a condenser C is connected. In the embodiment shown in FIG. 1, the impulses of opposite direction connected to the fluorescent lamp are provided by the four semiconductor switching elements 1, 2, 3, 4 coupled in bridge. This semiconductor switching elements can be, e.g. by transistors, IGBT's, JFET's or MOFSET's. In a switched off (closed) state, the internal resistance of the semiconductor switching elements are high, preferably of 4 Mohm, or of higher, but in the switched on state very small, preferably of 1 Ohm or less.

The device comprises a bridge coupled AC/CD converter having of two DC inputs 6 and 9, the negative pole of the DC supply unit not shown in the Figure, to input 8, to the positive pole of the DC supply unit to the other input 9 is connected. The AC outputs of the bridge circuit are the terminals 13 and 15. Each of the bridge branches contains two semiconductor switching elements 1, 2 and 3, 4 coupled in series. The common point of semiconductor switching elements 1 and 2 are connected to terminal 13, whereas the common point of semiconductor switching elements 3 and 4 to terminal 15. The device comprises also a signal generator 10, which is connected preferably to the DC supply voltage inputs 8 and 9. Signal generator 10 has two outputs 20 and 21 providing output signals in two phases. The first phase signal on the output 20 is connected to the control electrode 26 and 22 of the semiconductor switching elements 2 and 3 by line 12. The signal transmitted by line 12 of the signal generator 10 controls the state of the semiconductor switching elements 2 and 3 on and off. The second phase signal on the output 21 of the signal generator 10 controls the semiconductor switching elements 1 and 4 through line 11 coupled to the control electrodes 29 and 35 of the semiconductor switching elements 1 and 4.

Condenser 7 coupled parallel to fluorescent lamp 6 plays a role only until development of the plasma. In cooperation with the inductive coil 5, it provides an increased voltage as compared to that in the operation state to the electrode accelerating thereby the heating up of the electrodes. If the ignition is slower, i.e 10-400 ms visible by human eye, the condenser can be omitted.

The operation of fluorescent lamp 6 has four phases:

In the first phase, the direction of the current is the following: the negative input 8, semiconductor switching element 2, terminal 25 of the inductive coil 5, terminal 24 of the inductive coil 5, terminal 23 of the fluorescent lamp 6, and then, after ignition, terminal 22 of the fluorescent tube, other semiconductor switching element 3 and positive input 9. In this way charging up in the one direction is fulfilled. The other semiconductor switching elements 1 and 4 are switched off.

In the second phase, the voltage at the first phase output 20 of the signal generator 10 drops to zero, semiconductor switching elements 2 and 3 close (switch off), thus all the semiconductor switching elements 1,2,3 and 4 are in the closed state. The serial circuit comprising the inductive coil 5 and fluorescent lamp 6 becomes separated. This is the moment when the resonance of the serial circuit comprising inductive coil L and the fluorescent lamp 6 starts.

In the third phase, the voltage on the second phase output 21 of voltage generator 10 changes to high, fluorescent lamp 6 charges to the opposite polarity, and current starts into the opposite direction than in the first phase. Consequently, electrons start to charge the other side output 22 of fluorescent lamp 6 from the negative input 8 via semiconductor switching element 4, then after ignition, charges flowing through output 23, inductive coil 5 and the other semiconductor switching element 1 to positive input 9.

In the fourth phase, each semiconductor switching elements 1, 2, 3 and 4 are closed. It is similar to phase 3, the difference is that self-resonance starts from the other direction.

Then, the first phase starts again.

According to another further preferable embodiment of the invention, is, one of the half-bridges comprise condensers instead of the semiconductor switching elements. This arrangement is shown in FIG. 2.

The in bridge-coupled device has two inputs 28 and 29, the negative pole of the DC power supply unit is coupled input 28 the other positive pole of the DC power supply unit is connected to input 29. The AC output of the of bridge are terminals 213 and 215. One of the bridge branches comprises two semiconductor switching elements 21 and 22. The other bridge branch contains two condensers 24 and 23. The common point of semiconductor switching elements 21, 22 is connected to terminal 213, whereas the common point of condensers 23, 24 to terminal 215. At the same time, a signal generator 210 is also coupled to the DC power supply unit. Signal generator 210 has two outputs 220, 221 providing two different phase shifted output signals. In the first phase output 220 is connected to the control electrode 229 of the semiconductor switching element 21 by line 211. The second phase output 221 is coupled to the control electrode 226 of the other semiconductor switching element 22 by line 212.

During operation the four phases of the fluorescent lamp 6 are as follows:

In the first phase electrons flow from the negative input 28 via semiconductor switching elements 22 to terminal 225 of the inductive coil 25, the other terminal 224 of which to terminal 223 of the fluorescent lamp 6. After ignition, the electrons flow via line 215 through output 222 and through condenser 24 to the positive input 29 realizing thereby the charging in one of the directions. The other semiconductor switching element 21 is in this state closed.

In the second phase, the voltage at the first phase output 220 of the signal generator 210 drops to zero, and the semiconductor switching elements 21 and 22 are closed. Then, the serial circuit 26 comprising inductive coil 25 and fluorescent lamp 26 is separated. The resonance starts at the frequency of the serial circuit.

In the third phase, the voltage on output 21 of the signal generator 210 changes to high, and fluorescent lamp 26 is charged with the opposite polarity, current starts to flow into the opposite direction relative to the first phase. Then, electrons start to charge the other output 222 of the fluorescent lamp 6 from the negative output 28 via line 216 through condenser 27. After ignition of the fluorescent lamp 6, the electrons flow via terminal 223 to terminal 224 of the inductive coil 25 via line 214. Terminal 225 of the inductive coil 25 is connected through the line 213 terminal 230 of the other semiconductor switching element 21. Terminal 231 of the semiconductor switching elements 21 is connected to the positive input 29 of the DC supply unit via line 217.

In the fours phase, both semiconductor switching elements are closed. The situation is similar to that in phase third with the difference that self-oscillation starts from the other direction.

Then, the first phase starts again.

1-10. (canceled)

11. Device for ignition and operation of discharge tubes using a bridge-coupled DC/AC converter, the discharge tube is connected to the AC output of the bridge-coupled device, a condenser (7, 27) is coupled parallel with the discharge tube (6, 26) and an inductive coil (5, 25) is coupled in series with the discharge tube (6,26) in a way that they forming together an oscillating circuit of a given resonance frequency, and at least one of the half-bridges of the bridge-coupled circuit is formed by two semiconductor switching elements (1,2; 21,22) connected in series between the two inputs (8, 9; 28,29), the control electrodes of semiconductor switching elements (1,2; 21,22) are connected to the outputs (20, 21) of a signal generator (10, 21) which provide alternatively impulses to control electrodes, the control impulses are shifted in time and exciting a current flowing in the fluorescent tube (6) in opposite directions, and disconnecting the semiconductor switching elements (1,2; 21,22) in the intervals between the impulses, bringing in this way into resonance the oscillating circuit comprising the inductive coil (5, 25) and the discharge tube (6, 26), whereas the other half-bridge consists of AC coupling elements connected to the other input (9,8) and to the serial coupled circuit comprising the semiconductor switching elements (2, 1) actually switched on, characterized in that the resonance frequency is determined by an oscillating circuit formed by the condenser (7), the discharge tube (6, 26) and the inductive coil (5,25) and in that semiconductor switching elements (1,2; 21,22) in the intervals between the impulses are in closed galvanic separated state.

12. Device for ignition and operation discharge tubes according to claim 11 characterized in that the other half-bridge is formed by two semiconductor switching elements (3, 4) coupled in series.

13. Device for ignition and operation discharge tubes according to claim 11 characterized in that the other half-bridge is formed by two condensers (24, 23) coupled in series.

14. Device for ignition and operation discharge tubes according to claim 12 characterized in that by changing the capacity of the condensers (23, 24), the magnitude of the impulse can be changed.

15. Device for ignition and operation discharge tubes according to claim 12 characterized in that the capacity of the condensers (23, 24) determines the maximum value of the pulse impulse.

16. Device for ignition and operation discharge tubes according to claim 11 characterized in that the duration of control impulses and the intervals between them are identical.

17. Device for ignition and operation discharge tubes according to claim 11 characterized in that the control impulses are square wave pulses, and the shifts between the two signals are identical.

18. Device for ignition and operation discharge tubes according to claim 11 characterized in that by changing the pulse rate the illumination power can be regulated.

19. Device for ignition and operation discharge tubes according to claim 11 characterized in that that the capacitance of condenser (7, 27) coupled parallel to the discharge tube (2, 26) is some nF, preferably of 2 nF.

20. Device for ignition and operation discharge tubes according to claim 11 characterized in that the durations of impulses and duration of the intervals between the impulses are identical.
